(19) United States
(12) Patent Application Publication
(10) Pub. No.: US 2024/0070564 A1
(43) Pub. Date: Feb. 29, 2024

(54) TRAVEL PLAN GENERATING APPARATUS, TRAVEL PLAN GENERATING METHOD AND PROGRAM

(71) Applicant: NIPPON TELEGRAPH AND TELEPHONE CORPORATION, Tokyo (JP)

(72) Inventors: Kazuaki AKASHI, Musashino-shi, Tokyo (JP); Shunsuke KANAI, Musashino-shi, Tokyo (JP); Manami OGAWA, Musashino-shi, Tokyo (JP); Yusuke NAKANO, Musashino-shi, Tokyo (JP); Zhao WANG, Musashino-shi, Tokyo (JP)

(73) Assignee: NIPPON TELEGRAPH AND TELEPHONE CORPORATION, Tokyo (JP)

(21) Appl. No.: 18/280,268

(22) PCT Filed: Mar. 9, 2021
(86) PCT No.: PCT/JP2021/009359

§ 371 Date: Sep. 5, 2023

(51) Int. Cl. G06Q 10/047

(52) U.S. Cl. CPC G06Q 10/047

(57) ABSTRACT

A travel plan generation device according to an aspect of the present invention is provided with a generation unit that generates a travel plan for traveling a plurality of points by a plurality of mobile bodies by performing, at each output step, processing of selecting any one point out of the plurality of points and any one mobile body out of the plurality of mobile bodies by using a recurrent neural network configured to output visiting probabilities at the plurality of points and use probabilities of the plurality of mobile bodies when point information regarding the plurality of points and mobile body information regarding the plurality of mobile bodies are input, and an output unit that outputs the travel plan.

### TECHNICAL FIELD

The present invention relates to combination optimization such as a vehicle routing problem (VRP).

### BACKGROUND ART

The vehicle routing problem is a problem of acquiring an optimal travel plan under various constraint conditions (such as the number of vehicles, a loading capacity of the vehicle, for example) when delivering or picking up packages such as packages of a home delivery service or backup resources to a disaster-stricken area to and from a large number of points. The travel plan includes a route for each vehicle. The optimal travel plan refers to, for example, a travel plan in which the sum of travel distances is the shortest.

Since the number of patterns (combinations) of the routes is enormous, it is difficult to acquire a strictly optimal travel plan. Therefore, an approach of acquiring a travel plan close to the optimal one in a short time by utilizing machine learning is taken.

In the approach of solving the vehicle routing problem by utilizing machine learning, a method of using a recurrent neural network (RNN) to which an attention mechanism is introduced is known. Non Patent Literatures 1 and 2 disclose a method of acquiring a travel plan in a case where there is one vehicle. Non Patent Literature 3 discloses a method of acquiring a travel plan under a rule that a vehicle selects visiting points in predetermined order in a case where there is a plurality of vehicles. In Non Patent Literature 3, due to the above-described rule, the travel plan that may be output is restricted. Therefore, depending on a problem case, a travel plan that is not optimal might be acquired.

### CITATION LIST

### Non Patent Literature

Non Patent Literature 1: Irwan Bello, Hieu Pham, Quoc V. Le, Mohammad Norouzi, and Samy Bengio, “Neural Combinatorial Optimization with Reinforcement Learning,” arXiv preprint, arXiv:1611.09940, 2016.

Non Patent Literature 2: Mohammadreza Nazari, Afshin Oroojlooy, Martin Takao, and Lawrence V. Snyder, “Reinforcement Learning for Solving the Vehicle Routing Problem,” 32nd Conference on Neural Information. Processing Systems (2018).

Non Patent Literature 3: Jose Manuel Vera and Andres G. Abad, “Deep Reinforcement Learning for Routing a Heterogeneous Fleet of Vehicles,” IEEE LA-CCI, 2019.

### SUMMARY OF INVENTION

### Technical Problem

An object of the present invention is to provide a technology capable of acquiring a travel plan close to an optimal plan.

### Solution to Problem

A travel plan generation device according to an aspect of the present invention is provided with a generation unit that generates a travel plan for traveling a plurality of points by a plurality of mobile bodies by performing, at each output step, processing of selecting any one point out of the plurality of points and any one mobile body out of the plurality of mobile bodies by using a recurrent neural network configured to output visiting probabilities at the plurality of points and use probabilities of the plurality of mobile bodies when point information regarding the plurality of points and mobile body information regarding the plurality of mobile bodies are input, and an output unit that outputs the travel plan.

### Advantageous Effects of Invention

The present invention provides a technology capable of acquiring a travel plan close to an optimal plan.

### BRIEF DESCRIPTION OF DRAWINGS

FIG. 1 is a block diagram illustrating a travel plan generation device according to an embodiment of the present invention.

FIG. 2 is a diagram illustrating an RNN used by a travel plan generation unit illustrated in FIG. 1.

FIG. 3 is a diagram illustrating a specific example of the RNN used by the travel plan generation unit illustrated in FIG. 1.

FIG. 4 is a diagram illustrating a problem case handled by the travel plan generation device in FIG. 1.

FIG. 5 is a block diagram illustrating a hardware configuration of the travel plan generation device in FIG. 1.

FIG. 6 is a block diagram illustrating a learning device according to an embodiment of the present invention.

FIG. 7 is a flowchart illustrating an operation of the travel plan generation device in FIG. 1.

FIG. 8 is a diagram for explaining travel plan generation processing in the travel plan generation device in FIG. 1.

FIG. 9 is a diagram for explaining travel plan generation processing in the conventional art.

### DESCRIPTION OF EMBODIMENTS

Hereinafter, an embodiment of the present invention is described with reference to the drawings.

[Configuration]

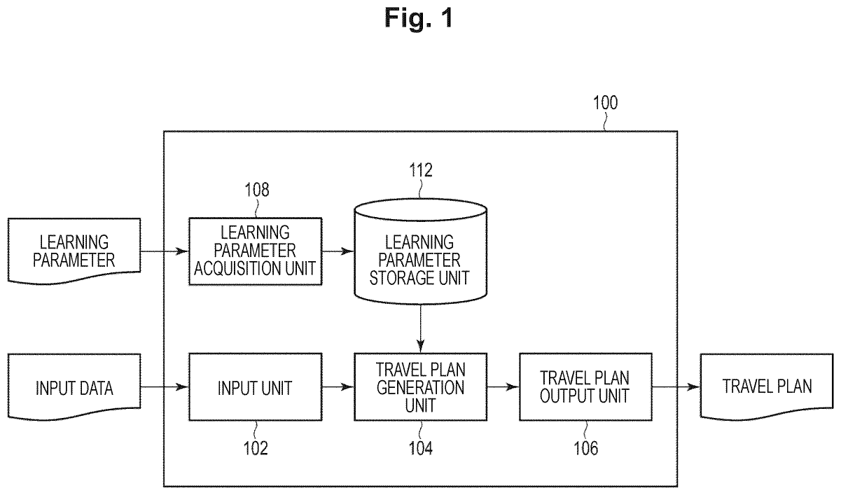

FIG. 1 schematically illustrates a travel plan generation device 100 according to an embodiment of the present invention. The travel plan generation device 100 illustrated in FIG. 1 generates a travel plan for traveling a plurality of points by a plurality of vehicles. For example, the travel plan generation device 100 determines routes of the plurality of vehicles in order to deliver packages to the plurality of points by the plurality of vehicles. A purpose of the vehicles to visit the points is not limited to package delivery. For example, the purpose may be package pickup. The purpose may be an action not involving package exchange. The travel plan includes a route for each vehicle. The route of each vehicle indicates points visited by the vehicle and order thereof.

In the example illustrated in FIG. 1, the travel plan generation device 100 is provided with an input unit 102, a travel plan Generation unit 104, a travel plan output unit 106, a learning parameter acquisition unit 108, and a learning parameter storage unit 112.

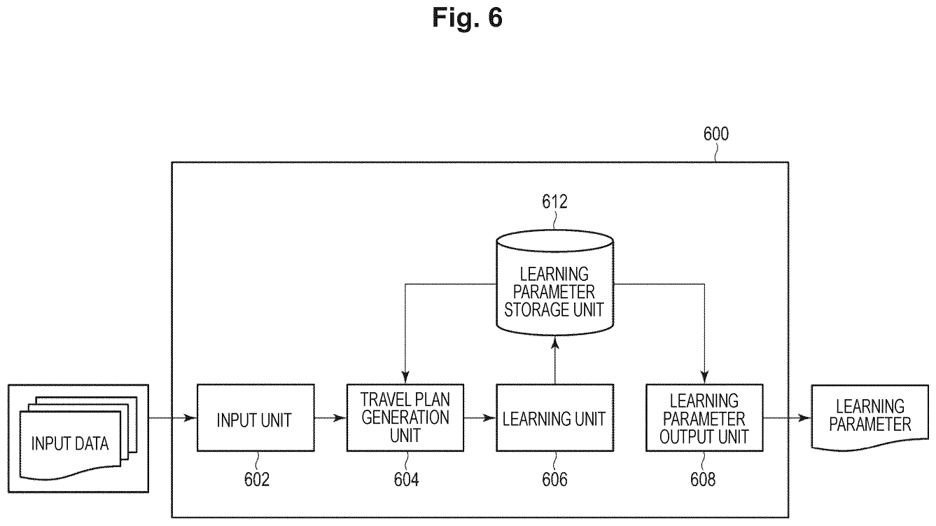

The learning parameter acquisition unit 108 acquires a learning parameter determined by a learning device 600 to be described later (FIG. 6) and stores the learning parameter in the learning parameter storage unit 112. In an example in which the travel plan Generation device 100 is connected to the learning device 600 via a network, the learning parameter acquisition unit 108 receives the learning parameter from the learning device 600 via the network. The learning parameter includes a weight applied to a neural network used by the travel plan generation unit 104.

The input unit 102 acquires point information regarding the plurality of points and vehicle information regarding the plurality of vehicles as input data. In an example in which the travel plan generation device 100 is connected to a terminal device used by a human operator via the network, the input unit 102 receives the input data from the terminal device via the network. Alternatively, the input unit 102 may receive the input data from an input device (for example, a keyboard) connected to the travel plan generation device 100. The input data includes information indicating a problem case for which the travel plan is generated. The point information includes information indicating positions and package request amounts (for example, amounts of packages to be delivered) of the plurality of points. The vehicle information includes information indicating positions and loading capacities (for example, amounts of loadable packages) of the plurality of vehicles.

The travel plan generation unit 104 generates the travel plan on the basis of the vehicle information and the point information acquired by the input unit 102. In order to generate the travel plan, the travel plan generation unit 104 may use a recurrent neural network (RNN) provided with an attention mechanism trained in advance. The travel plan generation unit 104 acquires the learning parameter from the learning parameter storage unit 112 and applies the learning parameter to the RNN.

The RNN is configured to output visiting probabilities at the plurality of points and use probabilities of the plurality of vehicles when the information and the vehicle information are input thereto. The visiting probability at each point is a probability that the vehicle will come to deliver the package under a certain situation of the point, and indicates likelihood that the point will be visited under a certain situation. The use probability of each vehicle is a probability of delivering the package under a certain situation of the vehicle, and indicates likelihood that the vehicle will be used under a certain situation. The travel plan generation unit 104 performs, at each output step, processing of selecting any one point out of the plurality of points and any one vehicle out of the plurality of vehicles us ng the RNN, and acquires the travel plan as a result. The output step is also referred to as a time step.

The travel plan output unit 106 outputs the travel plan generated by the travel plan generation unit 104. For example, the travel plan output unit 106 transmits the travel plan to the terminal device described above via the network. Alternatively, the travel plan output unit 106 may display the travel plan on a display device connected to the travel plan generation device 100.

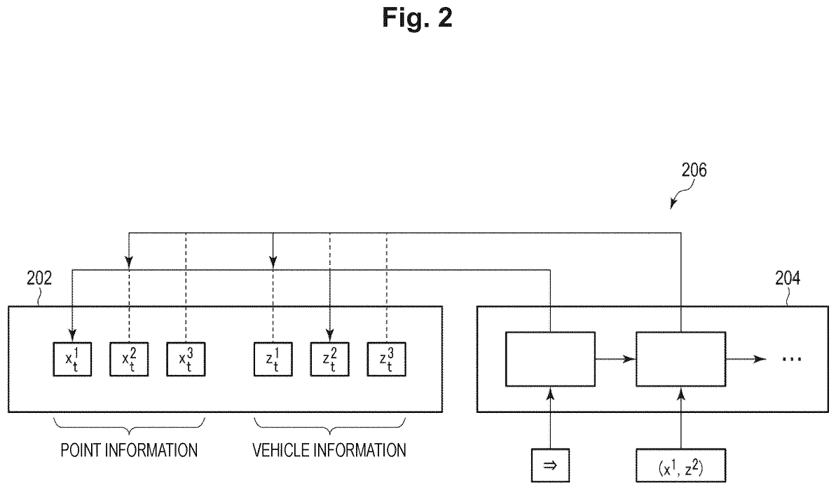

FIG. 2 schematically illustrates an example of the RNN used by the travel plan generation unit 104. In the example illustrated in FIG. 2, the RNN is provided with an encoder 202 and a decoder 204 as RNN modules, and an attention mechanism 206.

The travel plan generation unit 104 inputs the point information and the vehicle information to the encoder 202. The encoder 202 embeds the point information and the vehicle information in a space of a fixed number of dimensions. Specifically, the encoder 202 generates an embedded vector of a fixed number of dimensions corresponding to the point information, and generates an embedded vector of a fixed number of dimensions corresponding to the vehicle information. Hereinafter, the embedded vector corresponding to the point information is also referred to as a point information vector, and the embedded vector corresponding to the vehicle information is also referred to as a vehicle information vector. The encoder 202 provides the point information vector and the vehicle information vector to the attention mechanism 206.

The decoder 204 receives information regarding a point and a vehicle selected at a previous output step from the travel plan generation unit 104, and generates a hidden vector on the basis of the received information. The decoder 204 holds the hidden vector generated at the previous output step, and uses the held hidden vector to Generate a new hidden vector. Specifically, the decoder 204 generates the hidden vector at a current output step on the basis of the information regarding the point and vehicle selected at the previous output step and the hidden vector generated by itself at the previous output step. The decoder 204 provides the generated hidden vector to the attention mechanism 206.

The attention mechanism 206 calculates the visiting probability at the point and the use probability of the vehicle on the basis of the point information vector and the vehicle information vector received from the encoder 202 and the hidden vector received from the decoder 204.

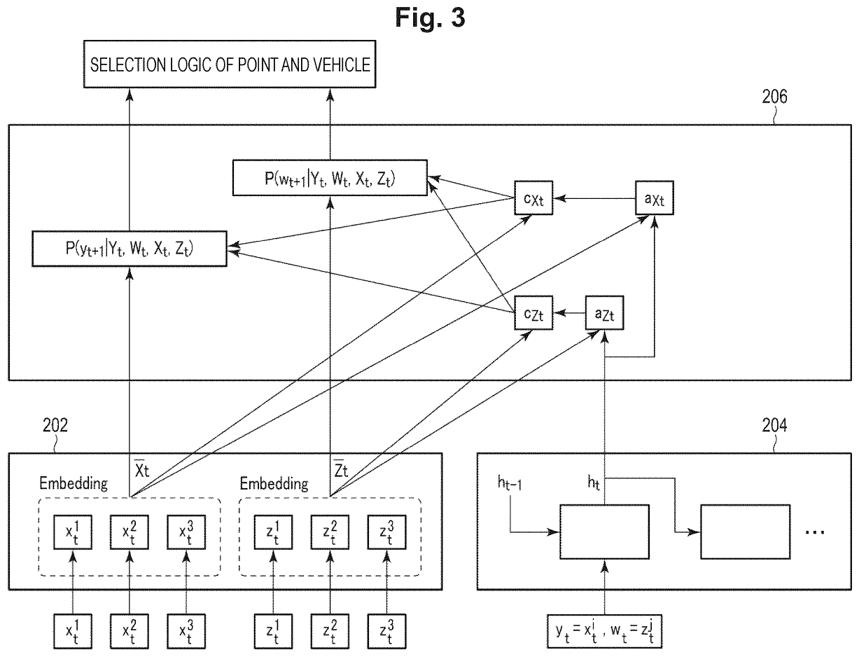

FIG. 3 schematically illustrates a specific example of the RNN illustrated in FIG. 2. In FIG. 3, Xₜ represents a vector indicating the point information at an output step t. The vector Xₜ may be expressed as follows.

Xₜ=(xₜ¹, xₜ², . . . , xₜ^{N}) [Math. 1]

Herein, N represents the number of points. An i-th element xⁱₜ of the vector Xₜ indicates the point information at a point i. Any integer from 1 to N is represented by i.

Zₜ represents a vector indicating the vehicle information at the output step t. The vector Zₜ may be expressed as follows.

Zₜ=(zₜ¹, zₜ², . . . , zₜ^{M}) [Math. 2]

Herein, M represents the number of vehicles. A j-th element z^{j}ₜ of the vector Zₜ indicates the vehicle information of a vehicle j. Any integer from 1 to M is represented by j.

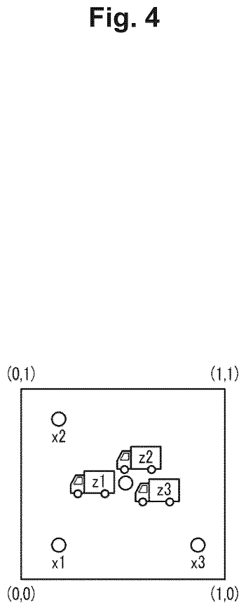

FIG. 4 schematically illustrates an example of the problem case handled by the travel plan generation device 100. Specifically, FIG. 4 illustrates the problem case in which vehicles z1, z2, and z3 each with a loading capacity of “ten” are present at a departure point at coordinates (0.5,0.5), packages of a requested amount of “eight” are delivered to a point x1 at coordinates (0.1,0.1), packages of a requested amount of “three” are delivered to a point x2 at coordinates (0.1,0.9), and packages of a requested amount of “5” are delivered to a point x3 at coordinates (0.9,0.1). In this case, a vector X₀ and a vector Z₀ corresponding to the point information and the vehicle information acquired by the input unit 102, respectively, are expressed as follows.

X₀=((0.1,0.1,8), (0.1,0.9,3), (0.9,0.1,5))

Z₀=((0.5,0.5,10), (0.5,0.5,10), (0.5,0.5,10)) [Math. 3]

Referring hack to FIG. 3, yₜ=xⁱₜ indicates information regarding the point selected at the output step t. Yₜ represents a vector indicating the information regarding the point selected at output steps 0 to t. The vector Yₜ may be expressed as follows.

Yₜ=(y₀, y₁, . . . , yₜ) [Math. 4]

The information regarding the vehicle selected at the output step t is indicated by wₜ=z^{j}ₜ. Wₜ represents a vector indicating the information regarding the vehicle selected at output steps 0 to t. The vector Wₜ may be expressed as follows.

Wₜ=(w₀, w₁, . . . , wₜ) [Math. 5]

The attention mechanism 206 receives the point information vector and the vehicle information vector from the encoder 202. The point information vector is the embedded vector generated from the vector Xₜ, and the vehicle information vector is the embedded vector generated from the vector Zₜ.

### [Math. 6]

Point information vector is represented by X̅ₜ, and i-th element of point information vector X̅ₜ is represented by x̅ₜⁱ. Furthermore, vehicle information vector is represented by Z̅ₜ, and j-th element of vehicle information vector Z̅ₜ is represented by z̅ₜⁱ.

The attention mechanism 206 further receives a hidden vector hₜ from the decoder 204. The attention mechanism 206 calculates the visiting probabilities at the plurality of points and the use probabilities of the plurality of vehicles on the basis of the point information vector, the vehicle information vector, and the hidden vector hₜ.

The attention mechanism 206 generates an attention vector a_{Xt} indicating a weight for the point information on the basis of the point information vector and the hidden vector hₜ. The attention vector a_{Xt} may be expressed as follows.

a_{Xt}=softmax(u_{Xt})

u_{Xt}ⁱ=v_{Xa}^{T}tanh(W_{Xa}[x̅ₜⁱ; hₜ]) [Math. 7]

Herein, a superscript T indicates transposition of a matrix. An operator “;” indicates concatenation. For example, A;B means concatenating a vector A with a vector B. The learning parameters are represented by v_{Xa} and W_{Xa}. A value indicating importance (weight) o£ the information of the point i when outputting the visiting probability at the output step t is represented by uⁱ_{Xt}.

The attention mechanism 206 generates a context vector c_{Xt} indicating a weighted sum of the point information on the basis of the point information vector and the attention vector a_{Xt}. The context vector c_{Xt} may be expressed as follows.

$${c}_{Xt} = {\sum }_{i = 1}^{N} {a}_{Xt}^{i} {\overline{x}}_{t}^{i} \qquad [ Math . 8 ]$$

The attention mechanism 206 generates an attention vector a_{Zt} indicating a weight for the vehicle information on the basis of the vehicle information vector and the hidden vector hₜ. The attention vector a_{Zt} may be expressed as follows.

a_{Zt}=softmax(u_{Zt})

u_{Zt}ⁱ=v_{Za}^{T}tanh(W_{Za}[z̅ₜ^{j}; hₜ] [Math. 9]

Herein, v_{Za} and W_{Za} represent the learning parameters. A value indicating importance (weight) of the information of a vehicle j when outputting the use probability at the output step t is represented by uⁱ_{Zt}.

The attention mechanism 206 generates a context vector c_{Zt} indicating a weighted sum of the vehicle information on the basis of the vehicle information vector and the attention vector a_{Zt}. The context vector c_{Zt} may be expressed as follows.

$${c}_{Zt} = {\sum }_{j = 1}^{M} {a}_{Zt}^{j} {\overline{z}}_{t}^{j} \qquad [ Math . 10 ]$$

The attention mechanism 206 calculates a visiting probability P(yₜ₊₁|Yₜ, Wₜ, Xₜ, Zₜ) at the plurality of points on the basis of the point information vector and the context vectors c_{Xt} and c_{Zt}. The visiting probability P(yₜ₊₁|Yₜ, Wₜ, Xₜ, Zₜ) may be expressed as follows.

P(yₜ₊₁|Yₜ, Wₜ, Xₜ, Zₜ)=softmax(u′_{Xt})

u′_{Xt}ⁱ=v_{Xc}^{T}tanh(W_{Xc}[x̅ₜⁱ; c_{Xt}; c_{Zt}]) [Math. 11]

Herein, yₜ₊₁ indicates a point selected at an output step t+1. The learning parameters are represented by v_{Xc} and W_{Xc}. A value indicating likelihood that the point i will be visited when outputting the visiting probability at the output step t is represented by u′ⁱ_{Xt}.

The attention mechanism 206 calculates a use probability P(wₜ₊₁|Yₜ, Wₜ, Xₜ, Zₜ) of the plurality of vehicles on the basis of the vehicle information vector and the context vectors c_{Xt} and c_{Zt}. The use probability P(wₜ₊₁|Yₜ, Wₜ, Xₜ, Zₜ) may be expressed as follows.

P(wₜ₊₁|Yₜ, Wₜ, Xₜ, Zₜ)=softmax(u′_{Zt})

u′_{Zt}^{j}=v_{Zc}^{T}tanh(W_{Zc}[z̅ₜ^{j}; c_{Xt}; c_{Zt}]) [Math. 12]

Herein, wₜ₊₁ indicates a vehicle selected at an output step t+1. The learning parameters are represented by v_{Zc} and W_{Zc}. A value indicating likelihood that the vehicle will be used when outputting the use probability at the output step t is represented by u′^{j}_{Zt}.

The travel plan generation unit 104 acquires the visiting probability at the point and the use probability of the vehicle from the RNN, and selects a point of the largest visiting probability and a vehicle of the largest use probability. The travel plan generation unit 104 adds the selected point to the route of the selected vehicle.

The travel plan generation unit 104 may perform masking when selecting the point and the vehicle. The travel plan generation unit 104 holds the mask information including point mask information indicating an unselectable point and vehicle mask information indicating an unselectable vehicle. The travel plan generation unit 104 selects out of the points excluding the unselectable point indicated by the point mask information and the vehicles excluding the unselectable vehicle indicated by the vehicle mask information. For example, the travel plan generation unit 104 changes the visiting probability at the point indicated as the unselectable point in the point mask information to zero and selects the point of the largest visiting probability, and changes the use probability of the vehicle indicated as the unselectable vehicle in the mask information to zero and selects the vehicle of the largest use probability.

The travel plan generation unit 104 updates the mask information on the basis of a result of adding the selected point to the route of the selected vehicle. For example, in a case where, as a result of adding a certain point to the route of a certain vehicle, the package request amount at this point becomes zero, the travel plan generation unit 104 adds this point to the point mask information as the unselectable point. In a case where, as a result of adding a certain point to the route of a certain vehicle, the loading capacity of this vehicle becomes zero, the travel plan generation unit 104 adds this vehicle to the vehicle mask information as the unselectable vehicle.

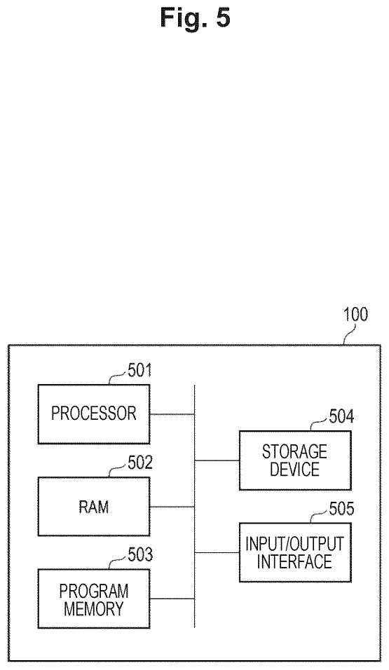

FIG. 5 schematically illustrates a hardware configuration example of the travel plan generation device 100. In the example illustrated in FIG. 5, the travel plan generation device 100 is provided with a processor 501, a random, access memory (RAM) 502, a program memory 503, a storage device 504, and an input/output interface 505. The processor 501 controls the RAM 502, the program memory 503, the storage device 504, and the input/output interface 505 and exchanges signals with them.

The processor 501 includes a general-purpose circuit such as a central processing unit (CPU) or a graphics processing unit (GPU). The RAM 502 is used by the processor 501 as a working memory. For example, the RAM 502 is used for holding the mask information. The RAM 502 includes a volatile memory such as an SDRAM. The program memory 503 stores programs executed by the processor 501, the programs including a travel plan generation program. The program includes a computer-executable instruction. For example, a ROM is used as the program memory 503. A partial area of the storage device 504 may be used as the program memory 503.

The processor 501 expands the program stored in the program memory 503 on the RAM 502 to interpret and execute the program. When executed by the processor 501, the travel plan generation program causes the processor 501 to perform a series of processing including the processing described regarding the travel plan generation unit 104 of the travel plan generation device 100.

The program may be provided to the travel plan generation device 100 in a state of being stored in a computer-readable recording medium. In this case, the travel plan generation device 100 is provided with a drive that reads data from the recording medium and acquires the program from the recording medium. Examples of the recording medium include a magnetic disk, an optical disk (such as CD-ROM, CD-R, DVD-ROM, and DVD-R), a magneto-optical disk (such as MO), and a semiconductor memory. The program may be distributed via a network. Specifically, the program may be stored in a server on the network, and the travel plan generation device 100 may download the program from the server.

The storage device 504 stores data such as the learning parameter. The storage device 504 includes a nonvolatile memory such as a hard disk drive (HDD) or a solid state drive (SSD).

The input/output interface 505 is provided with a communication module for communicating with an external device and a plurality of terminals for connecting peripheral devices. The communication module includes a wired module and/or a wireless module. Examples of the peripheral device include a display device, a keyboard, and a mouse. The processor 501 acquires The data such as the point information, the vehicle information, and the learning parameter via the input/output interface 505. The processor 501 outputs the travel plan via the input/output interface 505.

FIG. 6 schematically illustrates the learning device 600 according to an embodiment of the present invention. The learning device 600 illustrated in FIG. 6 trains the learning parameter of a neural network used by the travel plan generation device 100 illustrated in FIG. 1. The learning device 600 optimizes the learning parameter using results of a large number of times of simulations and the like.

As illustrated in FIG. 6, the learning device 600 is provided with an input unit 602, a travel plan generation unit 604, a learning unit 606, a learning parameter output unit 608, and a learning parameter storage unit 612. The learning device 600 may be implemented by causing a processor to execute a program. The learning device 600 may have a hardware configuration similar to that illustrated in FIG. 5.

The input unit 602 acquires a large number of learning data sets. The learning data set is prepared by, for example, random creation and the like. Each learning data set includes the point information and the vehicle information.

The travel plan generation unit 604 generates the travel plan on the basis of each learning data set. The travel plan generation unit 604 generates the travel plan by the same method as that of the travel plan generation unit 104 illustrated in FIG. 1. The travel plan generation unit 604 uses an RNN having the same configuration as that of the RNN used by the travel plan generation unit 104. The travel plan generation unit 604 generates the travel plan on the basis of the learning data set using the RNN to which the learning parameter stored in the learning parameter storage unit 612 is applied. The learning parameters include v_{Xa}, W_{Xa}, v_{Za}, W_{Za}, v_{Xc}, W_{Xc}, v_{Zc}, and W_{Zc} described above.

The learning unit 606 updates the learning parameter on the basis of the travel plan generated by the travel plan generation unit 604. As a learning algorithm, for example, an advantage actor critic (A2C) algorithm may be used.

The learning device 600 repeatedly performs processing including generation of the travel plan and updating of the learning parameter. The learning parameter output unit 608 outputs a finally acquired learning parameter. For example, the learning parameter output unit 608 transmits the learning parameter to the travel plan generation device 100 illustrated in FIG. 1 via the network.

Note that, the learning device 600 is illustrated as a device different from the travel plan generation device 100, but the learning device 600 may be present in the travel plan generation device 100.

[Operation]

Next, an operation of the travel plan generation device 100 is described.

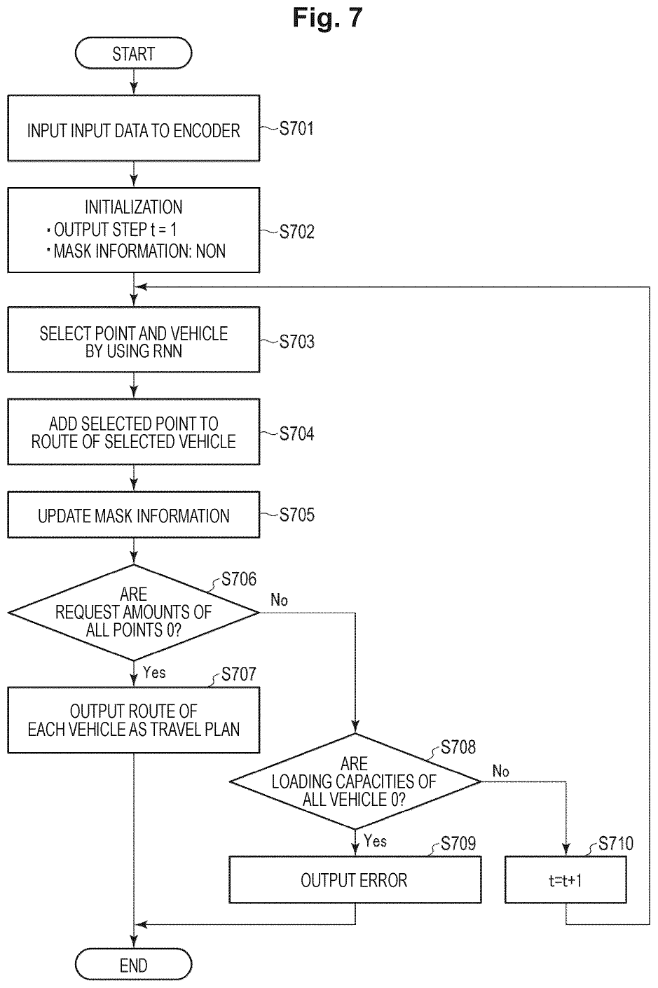

FIG. 7 schematically illustrates an operation example when the travel plan generation device 100 generates the travel plan. At step S701 in FIG. 7, the travel plan generation unit 104 receives the input data including the point information and the vehicle information from the input unit 102, and inputs the input data to the encoder 202 of the RNN. At step S702, the output step and the mask information are initialized. For example, the output step t is set to 1, and contents of the mask information are erased. The mask information includes the point mask information and the vehicle mask information.

At step S703, the travel plan generation unit 104 selects any one of the plurality of points and any one of the plurality of vehicles by using the RNN and referring to the mask information. For example, the travel plan generation unit 104 inputs the point information and the vehicle information after processing at an output step t−1 ends and information regarding the point and vehicle selected at the output step t−1 to the RNN, and acquires the visiting probability at the point and the use probability of the vehicle output from the RNN. The travel plan generation unit 104 sets the visiting probability at a point specified according to the point mask information to zero, and sets the use probability of a vehicle specified according to the vehicle mask information to zero. Then, the travel plan generation snit 104 selects a point of the highest visiting probability and a vehicle of the highest use probability.

At step S704, the travel plan generation unit 104 adds the selected point to the route of the selected vehicle. The travel plan generation unit 104 further generates the point information and the vehicle information at a next output step. At step S705, the travel plan generation unit 104 updates the mask information. For example, the travel plan generation unit 104 determines a point at which the package request amount is zero as the unselectable point. The travel plan generation unit 104 determines a vehicle with the loading capacity of zero as the unselectable vehicle.

In the problem case illustrated in FIG. 4, it is assumed that the travel plan generation unit 104 selects the point x1 and the vehicle z1. In this case, the travel plan generation unit 104 adds the point x1 to the route of the vehicle z1. The package request amount at the point x1 is “eight”, and the loading capacity of the vehicle z1 is “ten”. Therefore, the vehicle z1 may load all the packages to be delivered to the point x1. The travel plan generation unit 104 changes the package request amount at the point x1 to zero, changes the position of the vehicle z1 to coordinates (0.1,0.1), and changes the loading capacity of the vehicle z1 to two. In response to the fact that the package request amount at the point x1 becomes zero, the travel plan generation unit 104 determines the point x1 as the unselectable point, and adds information indicating that the point x1 is the unselectable point to the point mask information.

At step S706, the travel plan generation unit 104 determines whether the package request amounts at all the points are zero. In a case where the package request amount at any point is not zero (step S706; No), the procedure shifts to step S708.

At step S708, the travel plan generation unit 104 determines whether the loading capacities of all the vehicles are zero. In a case where the loading capacities of all the vehicles are zero (step S708; Yes), the procedure shifts to step S709. When the procedure shifts to step S709, this means that not all the packages can be delivered by M vehicles. At step S709, the travel plan output unit 106 outputs information indicating an error.

In a case where the loading capacity of any vehicle is not zero (step S708; No), the procedure shifts to step S710. At step S710, the output step t is incremented by 1, and the procedure returns to step S703. Steps S703 to S705 are repeatedly executed.

In a case where the package request amounts at all the points are zero (step S706; Yes), the procedure shifts to step S707. At step S707, the travel plan output unit 106 outputs the route of each vehicle as the travel plan.

[Effect]

In the travel plan generation device 100 according to this embodiment, the travel plan generation unit 104 generates the travel plan by performing, at each output step, the processing of selecting any one point out of the plurality of points and any one vehicle out of the plurality of vehicles using the RNN configured to output the visiting probabilities at the plurality of points and the use probabilities of the plurality of vehicles when the point information regarding the plurality of points and the vehicle information regarding the plurality of vehicles are input thereto. By selecting the point and the vehicle using the RNN, it becomes possible to acquire the travel plan close to an optimal plan.

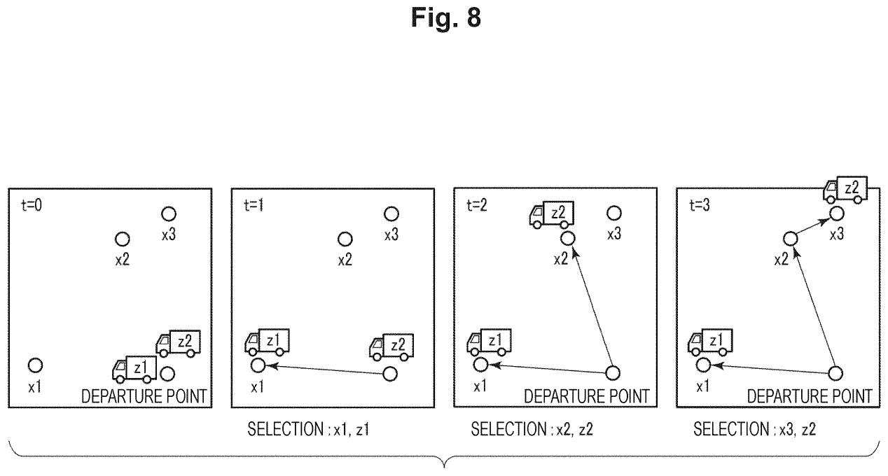

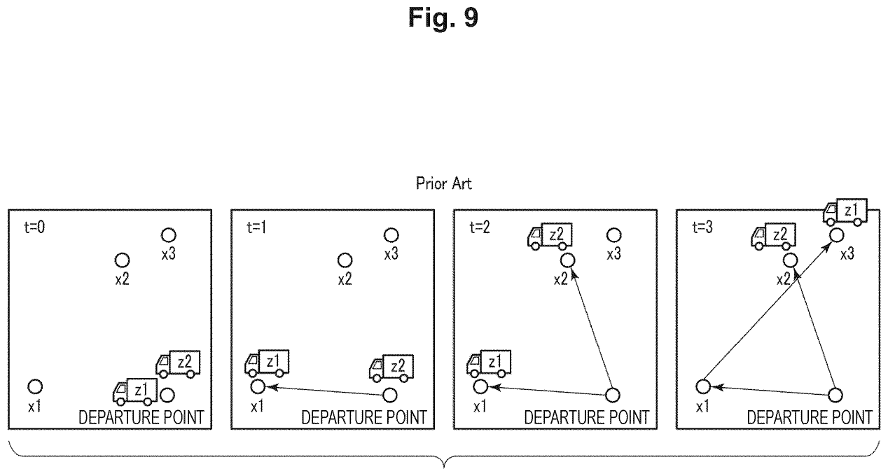

FIG. 8 schematically illustrates travel plan generation processing in the travel plan generation device 100, and FIG. 9 schematically illustrates travel plan generation processing in the technology disclosed in Non Patent Literature 3.

The technology disclosed in Non Patent Literature 3 generates the travel plan according to a rule of selecting the vehicles is predetermined order. For example, is a case where there are three vehicles z1, z2, and z3, the vehicle z1 is selected and a point to be visited by the vehicle z1 is selected, the vehicle z2 is selected and a point to be visited by the vehicle z2 is selected, and the vehicle z3 is selected and a point to be visited by the vehicle z3 is selected. This operation is repeated. In the problem case illustrated in FIG. 9, there are three points x1, x2, and x3, and two vehicles z1 and z2. At t=1, the vehicle z1 is selected, and the point x1 is added to the route of the vehicle z1. At t=2, the vehicle z2 is selected, and the point x2 is added to the route of the vehicle z2. At t=3, the vehicle z1 is selected, and the point x3 is added to the route of the vehicle z1. Since the vehicles z1 and z2 are alternately selected, the point x3 is assigned to the vehicle z1. However, the total sum of travel distances is smaller when the vehicle z2 visits the point x3 than when the vehicle z1 visits the point x3. Therefore, the acquired travel plan an is not an optimal solution.

In contrast, the travel plan generation device 100 selects the vehicles in any order. Specifically, the travel plan generation device 100 repeats processing of selecting any point and any vehicle using the RNN. The travel plan generation device 100 may generate the travel plan as illustrated in FIG. 8. Specifically, at t=1, the point x1 and the vehicle z1 are selected, and the point x1 is added to the route of the vehicle z1. At t=2, the point x2 and the vehicle z2 are selected, and the point x2 is added to the route of the vehicle z2. At t=3, the point x3 and the vehicle z2 are selected, and the point x3 is added to the route of the vehicle z2. As a result, the travel plan in which the vehicle z1 visits the point x1 and the vehicle z2 visits the points x2 and x3 is generated. The travel plan generation device 100 may acquire the travel plan in which the total sum of the travel distances is smaller. In this manner, this embodiment eliminates the restriction of the output due to the fixed selection order of the vehicles, and makes it possible to acquire a solution closer to the optimal solution in many cases.

The point information may include the positions and the package request amounts of the plurality of points, and the vehicle information may include the positions and the loading capacities of the plurality of vehicles. Even in a complicated problem case in which it is necessary to consider the package request amount at the point and the loading capacity of the vehicle, the travel plan may be acquired in a short time by using the RNN.

The encoder 202 of the RNN generates the point information vector that is an embedded vector corresponding to the point information and the vehicle information vector that is an embedded vector corresponding to the vehicle information, the decoder 204 of the RNN generates the hidden vector on the basis of the point and the vehicle selected at the previous output step, and the attention mechanism 206 of the RNN calculates the visiting probabilities at the plurality of points and the use probabilities of the plurality of vehicles on the basis of the point information vector, the vehicle information vector, and the hidden vector. The attention mechanism 206 generates a first context vector indicating the weighted sum of the point information on the basis of the point information vector and the hidden vector, and generates a second context vector indicating the weighted sum of the vehicle information on the basis of the vehicle information vector and the hidden vector. Then, the attention mechanism 206 calculates the visiting probabilities at the plurality of points on the basis of the point information vector, the first context vector, and the second context vector, and calculates the use probabilities of the plurality of vehicles on the basis of the vehicle information vector, the first context vector, and the second context vector. The visiting probabilities at the plurality of points and the use probabilities of the plurality of vehicles are calculated on the basis of both context vectors. This makes it possible to select the point and the vehicle in consideration of both the point information and the vehicle information. As a result, more appropriate selection may be expected.

The travel plan generation unit 104 selects one point out of the plurality of points excluding the point specified according to the point mask information on the basis of the visiting probabilities at the plurality of points output from the RNN, selects one vehicle out of the plurality of vehicles excluding the vehicle specified according to the vehicle mask information on the basis of the use probabilities of the plurality of vehicles output from the RNN, adds the selected point to the route of the selected vehicle, and updates the point mask information and the vehicle mask information on the basis of a result of adding the selected point to the route of the selected vehicle. By performing masking in the selection of the point and the vehicle, generation of a route including unnecessary movement is prevented, and the travel plan closer to the optimal plan may be acquired.

[Variation]

In the above-described embodiment, the vehicle visits the point. The vehicle is merely an example of a mobile body that visits the point. The mobile body may also be a human.

It is possible that point information does not include information indicating package request amounts at plurality of points, and vehicle information does not include information indicating loading capacities of a plurality of vehicles. For example, the point information may include only information indicating positions of the plurality of points, and the vehicle information may include only information indicating positions of the plurality of vehicles. In this case, the point once selected may be added to the point mask information as the unselectable point.

Note that, the present invention is not limited to the embodiment described above and various modifications may be made in the implementation stage without departing from the gist of the invention. The embodiments may be combined appropriately; in this case, combined advantageous effects may be obtained. Furthermore, the embodiment described above includes various inventions, and the various inventions might be extracted by a combination selected from a plurality of disclosed components. For example, in a case where the problem may be solved and the advantageous effects may be obtained despite elimination of some components from all the components described in the embodiment, a configuration from which the components are eliminated may be extracted as the invention.

### REFERENCE SIGNS LIST

100 Travel plan generation device
102 Input unit
104 Travel plan generation unit
106 Travel plan output unit
108 Learning parameter acquisition unit
112 Learning parameter storage unit
202 Encoder
204 Decoder
206 Attention mechanism
501 Processor
502 RAM
503 Program memory
504 Storage device
505 Input/output interface
600 Learning device
602 Input unit
604 Travel plan generation unit
606 Learning unit
608 Learning parameter output unit
612 Learning parameter storage unit

1. A travel plan generation device, comprising:
generation circuitry configured to generator a travel plan for traveling a plurality of points by a plurality of mobile bodies by performing, at each output step, processing of selecting any one point out of the plurality of points and any one mobile body out of the plurality of mobile bodies by using a recurrent neural network configured to output visiting probabilities at the plurality of points and use probabilities of the plurality of mobile bodies when point information regarding the plurality of points and mobile body information regarding the plurality of mobile bodies are input; and
output circuitry configured to output the travel plan.

2. The travel plan generation device according to claim 1, wherein the recurrent neural network includes:
an encoder that generates a first embedded vector corresponding to the point information and a second embedded vector corresponding to the mobile body information;
a decoder that generates a hidden vector on the basis of information regarding a point and a mobile body selected at a previous output step; and
attention circuitry configured to calculate the visiting probabilities at the plurality of points and the use probabilities of the plurality of mobile bodies on the basis of the first embedded vector, the second embedded vector, and the hidden vector.

3. The travel plan generation device according to claim 2, wherein the attention circuitry is further configured to:
generate a first context vector indicating a weighted sum of the point information on the basis of the first embedded vector and the hidden vector;
generate a second context vector indicating a weighted sum of the mobile body information on the basis of the second embedded vector and the hidden vector;
calculate the visiting probabilities at the plurality of points on the basis of the first embedded vector, the first context vector, and the second context vector; and
calculate the use probabilities of the plurality of mobile bodies on the basis of the second embedded vector, the first context vector, and the second context vector.

4. The travel plan generation device according to claim 1, wherein the processing includes:
selecting one point out of the plurality of points excluding a point specified according to first mask information indicating an unselectable point out of the plurality of points on the basis of the visiting probabilities at the plurality of points output from the recurrent neural network;
selecting one mobile body out of the plurality of mobile bodies excluding a mobile body specified according to second mask information indicating an unselectable mobile body out of the plurality of mobile bodies on the basis of the use probabilities of the plurality of mobile bodies output from the recurrent neural network;
adding the selected point to a route of the selected mobile body; and
updating the first mask information and the second mask information on the basis of a result of adding the selected point to the route of the selected mobile body.

5. The travel plan generation device according to claim 4, wherein:
the point information includes positions and package request amounts of the plurality of points,
the mobile body information includes positions and loading capacities of the plurality of mobile bodies,
the updating of the first mask information and the second mask information includes:
adding the selected point to the first mask information as the unselectable point in a case where a package request amount at the selected point becomes zero as a result of adding the selected point to the route of the selected mobile body; and
adding the selected mobile body to the second mask information as the unselectable mobile body in a case where a loading capacity of the selected mobile body becomes zero as a result of adding the selected point to the route of the selected mobile body.

6. The travel plan generation device according to claim 1, wherein:
the plurality of mobile bodies is a plurality of vehicles,
the mobile body information includes positions and loading capacities of the plurality of vehicles, and
the point information includes the position and package request amounts of the plurality points.

7. A travel plan generation method, comprising:
generating a travel plan for traveling a plurality of points by a plurality of mobile bodies by performing, at each output step, processing of selecting any one point out of the plurality of points and any one mobile body out of the plurality of mobile bodies by using a recurrent neural network configured to output visiting probabilities at the plurality of points and use probabilities of the plurality of mobile bodies when point information regarding the plurality of points and mobile body information regarding the plurality of mobile bodies are input; and
outputting the travel plan.

8. A non-transitory computer readable medium storing a program for causing a computer to serve as each element included in the travel plan generation device according to claim 1.

9. A non-transitory computer readable medium storing a program for causing a computer to perform the steps of claim 7.
